(19) United States
(12) Patent Application Publication
(10) Pub. No.: US 2015/0222066 A1
(43) Pub. Date: Aug. 6, 2015

(54) Slipring Brush with Controlled Current Density

(71) Applicant: Schleifring und Apparatebau GmbH, Furstenfeldbruck (DE)

(72) Inventor: Herbert STAFFLER, Furstenfeldbruck (DE)

(21) Appl. No.: 14/688,279

(22) Filed: Apr. 16, 2015

Related U.S. Application Data
(63) Continuation of application No. PCT/EP2012/070594, filed on Oct. 17, 2012.

(51) Int. Cl. H01R 39/26

(52) U.S. Cl. CPC H01R 39/26

(57) ABSTRACT

A slipring brush comprises a brush body of electrically conductive material, a contact wire for contacting the brush body and a spring for applying mechanical force to the brush body. The brush body has a contact surface for sliding on a slipring track. Furthermore, at least one blind hole is provided in the brush body beginning from the contact surface, to reduce the cross section of the brush body, increasing the current density. Due to the increased current density, wear is reduced and lifetime increased. The outer interface of the brush body remains unchanged.

### PRIORITY CLAIM

This application is a continuation of pending International Application No. PCT/EP2012/070594 filed on 17 Oct. 2012, which designates the United States, and which is incorporated by reference in its entirety.

### BACKGROUND OF THE INVENTION

1. Field of the Invention

The invention relates to a slipring brush, which may be used in an electrical power transfer device like a slipring or rotary joint, or in the collector of an electrical motor. Sliprings are used to transfer electrical power between rotating parts of machines like wind power plants, CT scanners or electrical generators. There a brush, mainly comprising of electrically conductive material like carbon is sliding on a rotating cylindrical track of conductive material. Common materials for such tracks are steel or brass.

2. Description of Relevant Art

Slipring brushes must have a low contact resistance to the track and a low contact noise during a long lifetime. Furthermore, wear of the track must be low, as replacement of the track is complex and expensive.

The U.S. Pat. No. 2,153,049 discloses a slipring brush having holes essentially parallel to the wearing face sliding on the track. When material of the brush is abraded by wear, the parallel rows get opened and form grooves extending diagonally across the wearing face. This should increase the electric contact by preventing build up of vacuum or pressure, which tends to develop under portions of the face of the brush and also by foreign particles of matter which attempt to pass under the brush.

A different solution is disclosed in the U.S. Pat. No. 6,091,178. This patent tries to reduce hydrodynamic forces between a brush and the track to obtain a good contact by providing a gap at a side of the brush.

The Chinese patent application publication 102082381 A discloses to provide a hole through a slipring brush for providing an exhaust duct for gases and particles.

### SUMMARY OF THE INVENTION

The embodiments are based on the object of providing a slipring brush with good contact properties, long lifetime and low track wear.

In an embodiment, a slipring brush with an essentially rectangular cross section has at least one blind hole in its contact surface. Preferably, the diameter and/or cross-section of the blind hole is adapted to the current flowing through the brush to obtain a specific current density. It is essential, that this blind hole ends within the brush and does not penetrate through the brush. A through hole would, as already observed in the prior art, lead to an exhaust of air and gases which adversely affect the thermal balance in the brush. It furthermore leads to an excessive current density within the contact area between the contacting wire and the brush due to the limited cross-section of the brush in the contact area. Such a through hole may be useful when operating a slipring brush and track at comparatively high power levels, where signal quality is not critical. When operating at moderate or lower power levels, transmission quality and lifetime can significantly be increased by carefully optimizing thermal and current balance. The blind hole in this embodiment defines a usable cross-section for the current flowing through the brush, resulting in a specific current density. Due to this specific density the wear of the track and of the brush are lower than with lower or higher current densities. Preferably, the current density is in the range of 1-100 A/mm2 of brush cross-section. Is further preferred to limit the current density to a range of 3-30 A/mm2. Here, a lower current density is even more critical to wear than a higher current density. As the blindfolded ends before the contact area between the contacting wire and the brush, the current density can be lowered within this area to provide for a long-term reliable contact.

This embodiment is based on Longtime observations of slipring tracks and brushes running thereon, which have shown that the current density in a slipring brush is critical for good contact characteristics, long lifetime and low track wear.

The advantage of this embodiment is that the outer size, which fits into a standard brush holder, must not be changed to adapt the brush to a variety of currents. Therefore, the outer size remains the same, while the cross-section of a different current can be individually adapted to the current to keep the current density in a predetermined range. This simplifies modification of existing systems as well as replacing existing brushes.

The blind hole must not necessarily be a round hole. Instead, it may have any shape, as long as it maintains a required cross-section of the surrounding brush body. It may for example be elliptical, triangular, or rectangular. Of course, there may also be a plurality of holes within the slipring brush body.

In a further embodiment, the blind hole is filled with insulating material. This insulating material prevents current flowing through the area of the blind hole and therefore keeps the current density as described above. Preferably, the insulating material is not only electrically insulating, but also thermally insulating to reduce an increase of the brush temperature. It may be PTFE (Teflon) or any other plastic material. Tests have shown, that the best results are obtained, when the holes are empty, forming a hollow space. Although holes filled with an insulator may be an alternative which is still an improvement over the prior art.

Preferably, a brush may comprise at least one of carbon material, metal powder like silver, and/or a lubricant. The lubricant may comprise oil or a material like Polytetrafluorethylene. Preferably, the brush is connected by a contact wire, which may be a litz wire to a contact plate.

### BRIEF DESCRIPTION OF THE DRAWINGS

In the following, the invention will be described by way of example, without limitation of the general inventive concept, on examples of embodiment and with reference to the drawings.

FIG. 1 shows a brush with a blind hole.

FIG. 2 shows a cross-section of the brush.

FIG. 3 shows a bottom view of the brush.

FIGS. 4 to 7 show further embodiments of the brush.

FIGS. 8 to 11 show embodiments with twin blind holes.

FIG. 12 shows a perspective view of the brush.

FIG. 13 shows a brush body filled with an insulating material.

FIG. 14 shows a sectional view showing the current density distribution.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

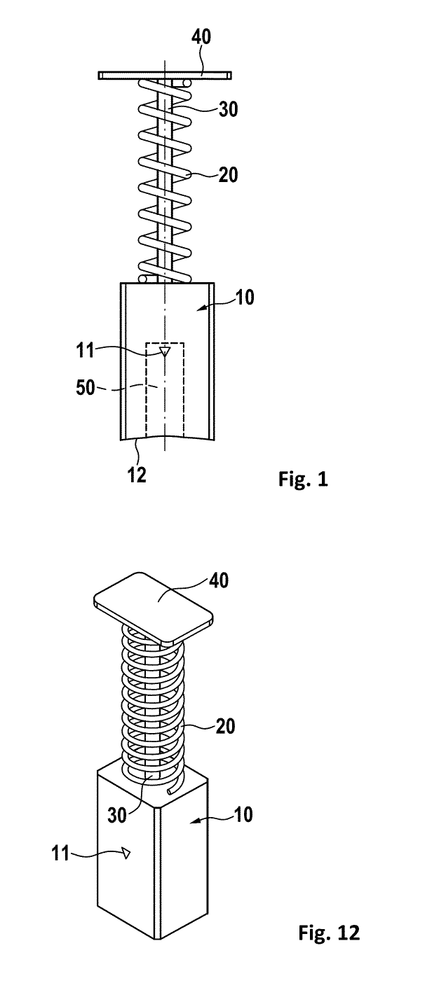

In FIG. 1, a preferred embodiment of a brush is shown. A brush body 10 of electrically conductive material, which may comprise at least one of carbon material, metal powder like silver, lubricant, is connected by a contact wire 30 to a contact plate 40. The contact wire preferably is a Litz wire. The contact plate 40 serves for the electric contact of the brush and may for example be contacted to a cable. For applying mechanical force to the brush body and pressing the brush to a sliding track, which is not shown here, a spring 20 may be provided. The brush body 10 has a contact surface 12 which contacts with sliding track. A wear marker may be provided at the surface of the brush to indicate a position to which the brush may be worn. When the wear marker has reached the sliding track or even has been worn off, the brush must be replaced. Furthermore, a blind hole 50 is provided within the brush body 10.

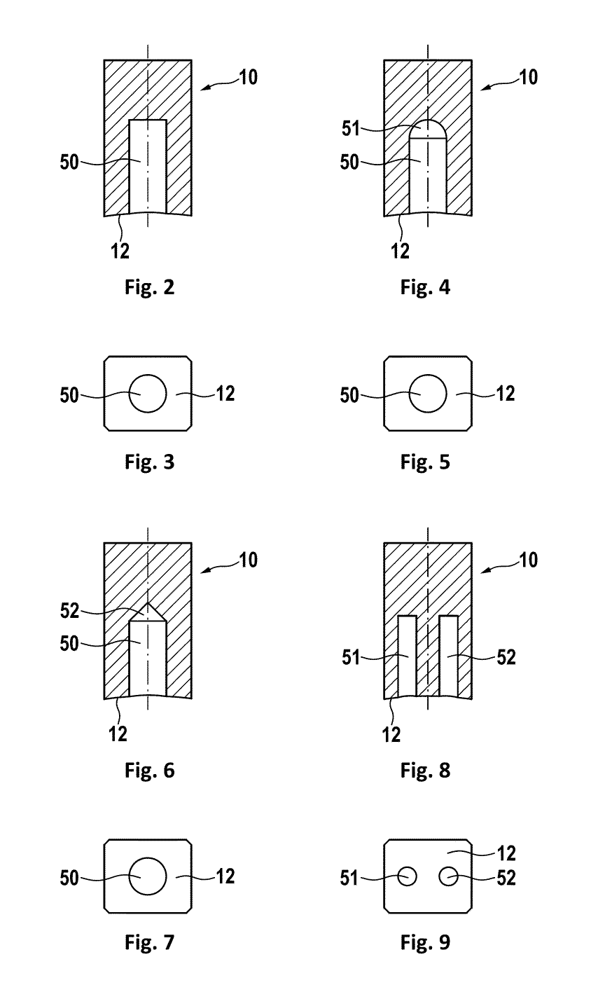

In FIG. 2, a cross-section of the brush is shown. It can be seen, that the blind hole 50 ends within the brush body and does not penetrate the brush. This is essential as described above.

FIG. 3 shows a bottom view of the brush. Here also the blind hole can be seen.

The FIGS. 4 to 7 show further embodiments of the brush. FIG. 4 shows a brush with a blind hole having a rounded end, while the brush of FIG. 6 has a blind hole with a conical end. FIG. 5 shows a bottom view of the brush of FIG. 4, while FIG. 7 shows a bottom view of the brush of FIG. 6.

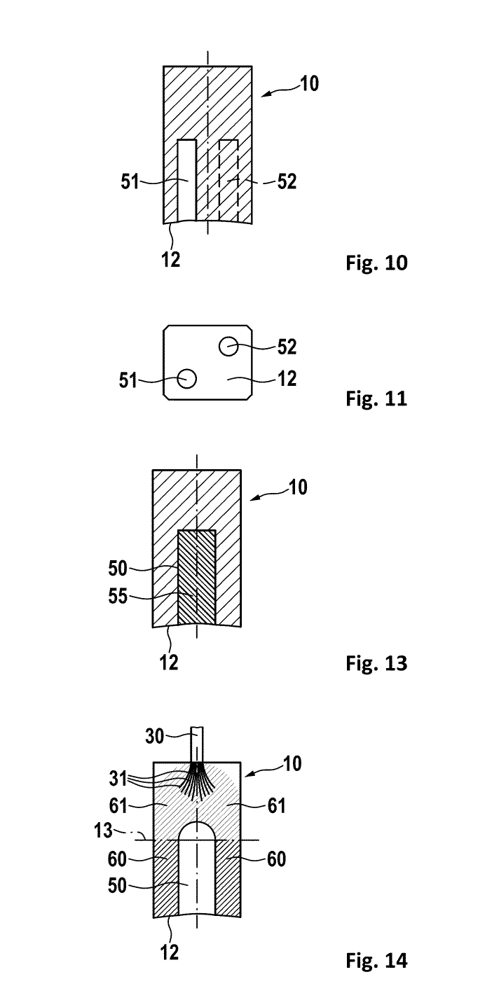

The FIGS. 8 to 11 show further embodiments of the brush with twin blind holes. As shown in FIG. 8, there may be two blind holes 51, 52 having approximately the same length. The respective bottom view is shown in FIG. 9. In FIG. 10 a brush with displaced twin blind holes 51, 52 is shown. The respective bottom view is shown in FIG. 11.

FIG. 12 shows a perspective view of the brush.

FIG. 13 shows a brush body filled with an insulating material 55, which may be PTFE or any other plastic material.

FIG. 14 shows a sectional view showing the current density distribution. The dashed line 13 shows the wear limit up to which the brush may be worn. This may correspond to the wear marker 11. In the area 60 besides of the hole and most preferably below the wear limit, there is a constant and relatively high current density colleges necessary to achieve good their characteristics. Above this area close to the contact area 31, where the contact wire 30 contacts the brush body 10, there is a region 61 with reduced current density.

It will be appreciated to those skilled in the art having the benefit of this disclosure that this invention is believed to provide a slipring brush with controlled current density. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 brush body
11 wear marker
12 contact surface
13 wear limit
20 spring
30 contact wire
31 contact area
40 contact plate
50 blind hole
51, 52 double blind holes
55 insulating material
60 area of higher current density
61 area of lower current density

1. A slipring brush comprising:
a brush body comprising electrically conductive material, the brush body having a contact surface,
a contact wire configured to contact the brush body, and
a spring configured to apply mechanical force to the brush body,
wherein the brush body defines at least one blind hole extending from the contact surface into the brush body.

2. The slipring brush according to claim 1, wherein the cross-section of the at least one blind hole is configured to a to obtain a specific current density in the brush body when a specific current flows through the brush body.

3. The slipring brush according to claim 1, wherein one blind hole is disposed at the center of the contact surface.

4. The slipring brush according to claim 1, wherein the at least one blind hole is filled with an insulating material.
